(19) United States
(12) Patent Application Publication
(10) Pub. No.: US 2025/0240535 A1
(43) Pub. Date: Jul. 24, 2025

(54) IMAGE SENSING DEVICE AND ANALOG TO DIGITAL CONVERTER OFFSET CONTROL METHOD

(71) Applicant: PixArt Imaging Inc., Hsin-Chu City (TW)

(72) Inventor: Chun Heap Leow, Penang (MY)

(73) Assignee: PixArt Imaging Inc., Hsin-Chu City (TW)

(21) Appl. No.: 18/419,581

(22) Filed: Jan. 23, 2024

(51) Int. Cl. H04N 23/74; G06F 3/0354; H04N 25/772

(52) U.S. Cl. CPC H04N 23/74; G06F 3/03543; H04N 25/772

(57) ABSTRACT

An image sensing device, comprising: a pixel array, configured to generate analog image sensing signals; an ADC, configured to transform the analog image sensing signals to digital optical image signals; and an offset control circuit, configured to adjust an ADC offset of the ADC corresponding to an image quality and an average pixel value of at least one image which is generated from previous analog image sensing signals sensed by the pixel array.

### BACKGROUND OF THE INVENTION

### 1. Field of the Invention

The present invention relates to an image sensing device and an ADC (Analog to Digital Converter) offset control method, and particularly relates to an image sensing device and an ADC offset control method which can automatically and dynamically adjust an ADC offset of an ADC in an image sensing device.

### 2. Description of the Prior Art

A conventional optical mouse may comprise an ADC and uses a fixed ADC offset to improve the image quality. However, such mechanism does not consider any light source power saving. Besides, the lighting time of the light source in the conventional optical mouse is not optimized when the optical mouse is moving on a high quality surface, since an image of the high quality surface does not need to have a high brightness for the optical mouse to perform a distance computation.

### SUMMARY OF THE INVENTION

One objective of the present invention is to provide an image sensing device which can save power when the motion can still be correctly computed.

Another objective of the present invention is to provide an ADC control method which can save power of an optical mouse when the motion can still be correctly computed.

One embodiment of the present invention discloses an image sensing device, comprising: a pixel array, configured to generate analog image sensing signals; an ADC, configured to transform the analog image sensing signals to digital optical image signals; and an offset control circuit, configured to adjust an ADC offset of the ADC corresponding to an image quality and an average pixel value of at least one image which is generated from previous analog image sensing signals sensed by the pixel array.

Another embodiment of the present invention discloses an ADC control method, applied to an image sensing device comprising a pixel array and an ADC, comprising: (a) generating analog image sensing signals by the pixel array; (b) transforming the analog image sensing signals to digital optical image signals by the ADC; and (c) adjusting an ADC offset of the ADC corresponding to an image quality and an average pixel value of at least one image which is generated from previous analog image sensing signals sensed by the pixel array.

Still another embodiment of the present invention discloses an electric apparatus, comprising: an image sensor, configured to sense a working surface which the electric apparatus is moved on and determine an image quality of the surface; and a light source, configured to illuminate the working surface with a first light intensity when the image quality is higher than a first image quality threshold, the light source is configured to illuminate the working surface with a second light intensity when the image quality is lower than a second image quality threshold, wherein the first light intensity is lower than the second light intensity.

In view of above-mentioned embodiments, power consumption of the optical mouse can be saved, since the lighting time of the light source can be decreased when the motion can still be correctly computed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an image sensing device according to one embodiment of the present invention.

FIG. 2 is a schematic diagram illustrating an optical mouse which comprises the image sensing device illustrated in FIG. 1, according to one embodiment of the present invention.

FIG. 3 is a schematic diagram illustrating the ADC offset control method performed by the image sensing device illustrated in FIG. 1, according to one embodiment of the present invention.

FIG. 4 is a schematic diagram illustrating a table of the operations illustrated in FIG. 3.

FIG. 5 is a schematic diagram illustrating the ADC offset control method performed by the image sensing device illustrated in FIG. 1, according to another embodiment of the present invention.

FIG. 6 is a flow chart illustrating an ADC offset control method, according to one embodiment of the present invention.

### DETAILED DESCRIPTION

In the following descriptions, several embodiments are provided to explain the concept of the present application. It will be appreciated that the system, the device, the apparatus or the module depicted in following embodiments can be implemented by hardware (ex. circuit) or the combination of hardware and software (ex. a processing unit executing at least one program). The term “first”, “second”, “third” in following descriptions are only for the purpose of distinguishing different one elements, and do not mean the sequence of the elements. For example, a first device and a second device only mean these devices can have the same structure but are different devices.

In addition, in following descriptions, an optical mouse is used an example for explaining. However, the image sensing device and the ADC offset control method disclosed in the present invention can be applied to any other optical device.

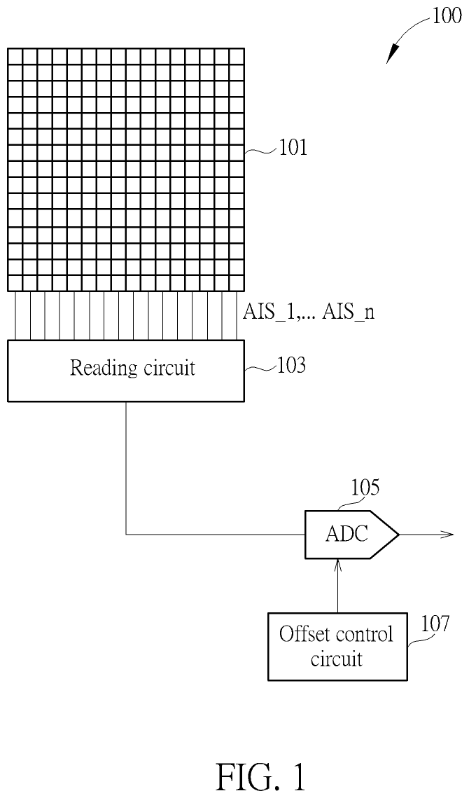

FIG. 1 is a schematic diagram illustrating an image sensing device 100 according to one embodiment of the present invention. As shown in FIG. 1, the image sensing device 100, which can be named as an image sensor, comprises a pixel array 101, a reading circuit 103, an ADC 105 and an offset control circuit 107. The pixel array 101 is configured to generate analog image sensing signals AIS_1 . . . . AIS_n. In one embodiment, the pixel array 101 comprises a plurality of pixel circuits, which can generate charges corresponding to light received by the pixel circuits. In such embodiment, the reading circuit 103 is configured to read the charges from the pixel circuits to generate the analog image sensing signals AIS_1 . . . . AIS_n.

The ADC 105 is configured to transform the analog image sensing signals AIS_1 . . . . AIS_n to digital optical image signals DIS_1 . . . . DIS_n. The offset control circuit 107 is configured to adjust an ADC offset of the ADC 105 corresponding to an image quality and an average pixel value of at least one image which is generated from previous analog image sensing signals sensed by the pixel array. For example, the pixel array 101 senses the analog image sensing signals, and a first image is generated according to the analog image sensing signals. After the first image, the pixel array 101 senses other analog image sensing signals, and a second image is generated according to the analog image sensing signals. In such case, the offset control circuit 107 adjusts the ADC offset for the second image corresponding to an image quality and an average pixel value of the first image. In one embodiment, the image sensing device 100 further comprises an ISP (Image Signal processor) to generate the first image and the second image.

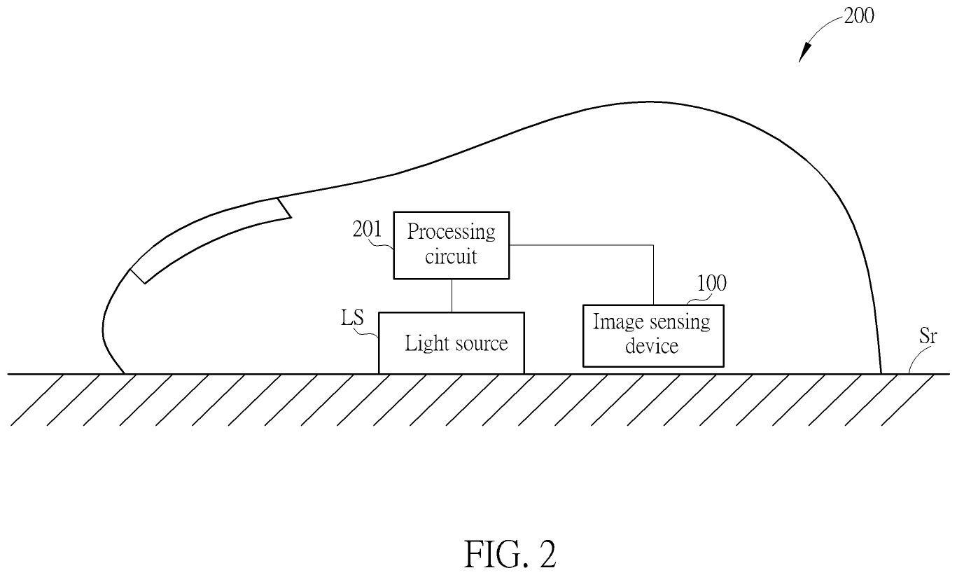

FIG. 2 is a schematic diagram illustrating an optical mouse which comprises the image sensing device 100 illustrated in FIG. 1, according to one embodiment of the present invention. As illustrated in FIG. 2, the optical mouse 200 comprises a processing circuit 201, a light source LS and the image sensing device 100. The optical mouse 200 is located on a working surface Sr, and the light source LS is configured to emit light outer the image sensing device 100 to the working surface Sr. The image sensing device 100 is configured to sense images according to reflected light from the surface Sr. The processing circuit 201 is configured to compute motions according to the images generated by the image sensing device 100.

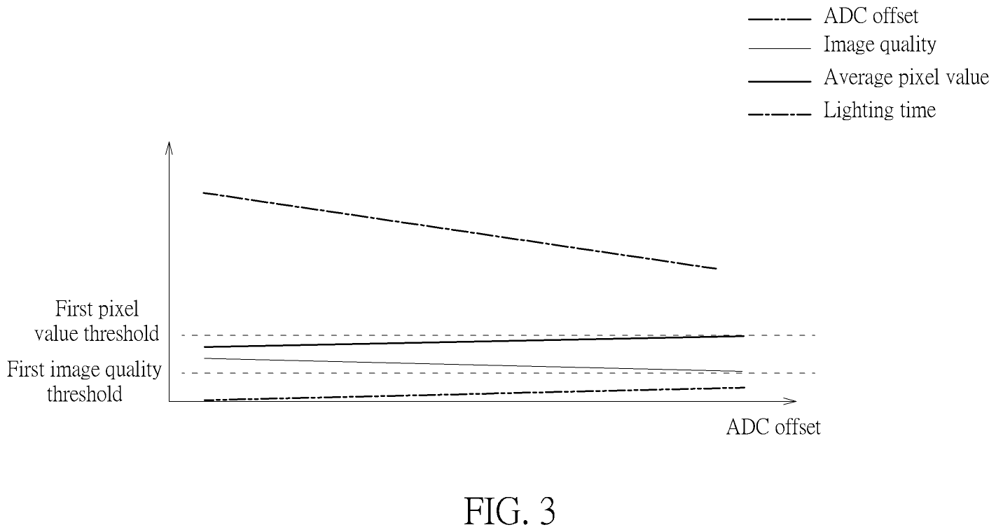

Please note, the motion computation can be performed by the image sensing device 100 rather than limited by the processing circuit 201 independent from the image sensing device 100. Also, in one embodiment, the processing circuit 201 is also configured to control the optical mouse 200 according to the motions. For example, the processing circuit 201 may control the optical mouse 200 to switch to a standby mode if the motion is low for a predetermine time interval and goes back to an active mode if the motion becomes from low to high. Besides, in the embodiment of FIG. 3, since the images sensed by the image sensing device 100 are images of the working surface Sr, the image quality of the images corresponds to a surface quality of the working surface Sr. In one embodiment, the surface quality means if the features (e.g., textures, marks, cracks) on the surface are obvious or not. The more obvious the feature (i.e., the feature level is high), the easier it is for the processing circuit 201 to calculate the correct motion, thus the surface quality is high in such condition. In such case, the image quality also means that the feature level of the images.

FIG. 3 is a schematic diagram illustrating the ADC offset control method performed by the image sensing device illustrated in FIG. 1, according to one embodiment of the present invention. In the embodiment of FIG. 3, the offset control circuit 107 increases the ADC offset if the image quality is higher than a first image quality threshold and the average pixel value is lower than a first pixel value threshold. A higher ADC offset means the ADC 105 adds a larger value to the pixel value while transforming the analog image sensing signals to the digital image sensing signals. For example, if the ADC 105 originally transforms the analog image sensing signals to pixel value 1, pixel value 2 . . . pixel value n. If the ADC offset is increased, the ADC 105 transforms the same analog image sensing signals to pixel value 1+k, pixel value 2+k . . . pixel value n+k. In other words, the image sensing device 100 adjusts the image to be brighter if the image quality of a previous image is higher than a first image quality threshold and the average pixel value of the previous image is lower than a first pixel value threshold.

In the embodiment of FIG. 3, the image sensing device 100 may have an auto exposure control mechanism, thus the lighting time (i.e., turn on time) of the light source LS decreases corresponding to the increasing of the ADC offset, as shown in FIG. 3. For more detail, the lighting time of the light source LS is controlled by the processing circuit 201 corresponding a brightness of a previous image. If the previous image is brighter, the next lighting time is decreased to avoid the pixel values of the image to be saturate, that is, to avoid the pixel values of the image to be over a saturate threshold. Accordingly, since the increasing of the ADC offset means the image brightness is increased, the lighting time of the light source LS decreases corresponding to the increasing of the ADC offset.

Additionally, in FIG. 3, the image quality may also decreases corresponding to the increasing of the ADC offset, since the image becomes brighter. However, the features in the images may still be obvious enough even if the image becomes brighter, when the surface quality is high. Further, as above-mentioned, the ADC offset means the increments for the pixel values, thus the average pixel value increases corresponding to the increasing of the ADC offset, as shown in FIG. 3.

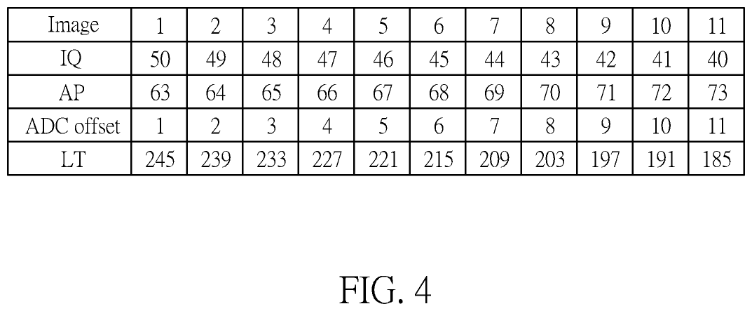

FIG. 4 is a schematic diagram illustrating a table of the operations illustrated in FIG. 3. Please note, FIG. 4 is only an example for explaining, the values shown in FIG. 4 do not mean to limit any scope of the present invention. Further, the values shown in FIG. 4 are only for showing variation tendencies, thus the units of each parameter are not illustrated in FIG. 4.

In FIG. 4, “image” means the sequence of images. For example, image 1 means an image sensed by the image sensing device 100 and image 2 means image which is sensed after the image 1. IQ means the above-mentioned image quality. AP means the average pixel value. ADC offset means the above-mentioned ADC offset. LT means the lighting time of the light source. As shown in FIG. 4, AP also increases when the ADC offset increases. On the opposite, IQ and LT decreases when the ADC offset increases. Accordingly, the values shown in FIG. 4 follow the tendencies shown in the line chart of FIG. 3.

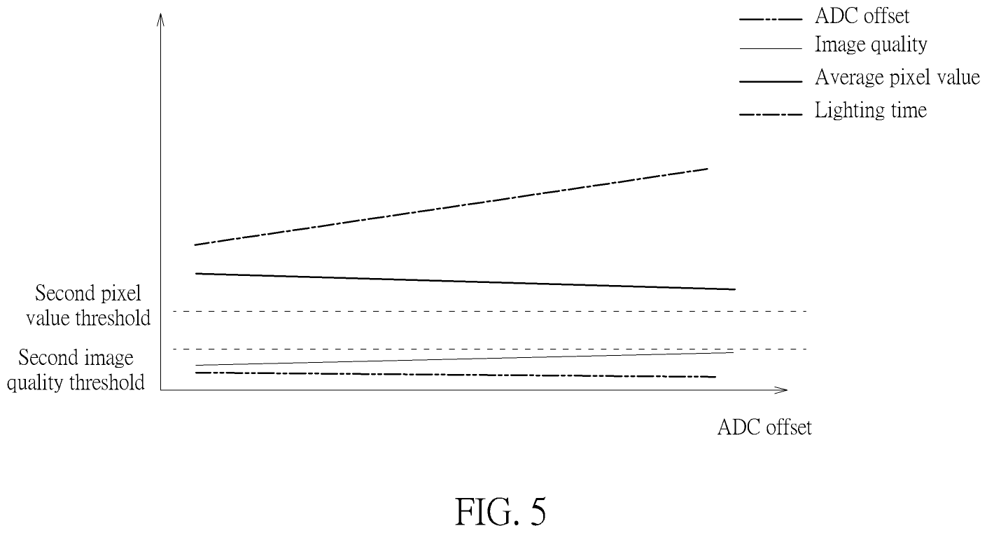

Besides automatically increase, the ADC offset can also automatically decrease corresponding to a specific condition. FIG. 5 is a schematic diagram illustrating the ADC offset control method performed by the image sensing device illustrated in FIG. 1, according to another embodiment of the present invention. In the embodiment of FIG. 5, the offset control circuit 107 decreases the ADC offset if the image quality is lower than a second image quality threshold and the average pixel value is higher than a second pixel value threshold. The second image quality threshold may be the same as the first image quality threshold, but may be different from the first image quality threshold as well. Also, the second pixel value threshold may be the same as the first pixel value threshold, but may be different from the first pixel value threshold as well.

As above-mentioned, a higher ADC offset means the ADC 105 adds a larger value to the pixel value while transforming the analog image sensing signals to the digital image sensing signals. Accordingly, a lower ADC offset means the ADC 105 adds a smaller value to the pixel value while transforming the analog image sensing signals to the digital image sensing signals. In other words, the image sensing device 100 adjusts the image to be darker if the image quality is lower than the second image quality threshold and the average pixel value is higher than the second pixel value threshold.

As above-mentioned, the image sensing device 100 may have an auto exposure control mechanism, thus the lighting time (i.e., turn on time) of the light source LS increases corresponding to the decreasing of the ADC offset, as shown in FIG. 5. For more detail, the lighting time of the light source LS is controlled by the processing circuit 201 corresponding a brightness of a previous image. If the previous image is darker, the next lighting time is increased to control the image brightness to approach a predetermined value. Accordingly, since the decreasing of the ADC offset means the image brightness is decreased, the lighting time of the light source LS increases corresponding to the decreasing of the ADC offset.

Additionally, in FIG. 5, the image quality may also increases corresponding to the decreasing of the ADC offset, if the image is already too bright. Further, as above-mentioned, the ADC offset means the increments for the pixel values, thus the average pixel value decreases corresponding to the decreasing of the ADC offset, as shown in FIG. 5.

The steps illustrated in FIG. 5 can follow the steps illustrated in FIG. 3. That is, if the average pixel value is high and the image quality is low due to the ADC offset is increased by the steps illustrated in FIG. 3, the ADC offset can be adjusted to be lower, such that the average pixel value can be decreased to approach a desired value and the image quality can be increased to a desired level. However, the steps in FIG. 5 can also be independently used for other applications rather than combined with the steps in FIG. 3.

The above-mentioned lighting time may be replaced by a light intensity. Also, the lighting time is decreased in FIG. 3 and increased in FIG. 5, thus the lighting time in FIG. 3 may be lower than which in FIG. 5. Accordingly, if the embodiments in FIG. 3 and FIG. 5 are combined, an electric apparatus provided by the present invention may be summarized as:

An electric apparatus comprising an image sensor (e.g., the image sensing device 100) and a light source is disclosed. The image sensor, configured to sense a working surface (e.g., the working surface Sr in FIG. 2) which the electric apparatus is moved on and determine an image quality of the surface; and a light source, configured to illuminate the working surface with a first light intensity when the image quality is higher than a first image quality threshold (e.g., the embodiment in FIG. 3). The light source is configured to illuminate the working surface with a second light intensity when the image quality is lower than a second image quality threshold (e.g., the embodiment in FIG. 5). The first light intensity is lower than the second light intensity.

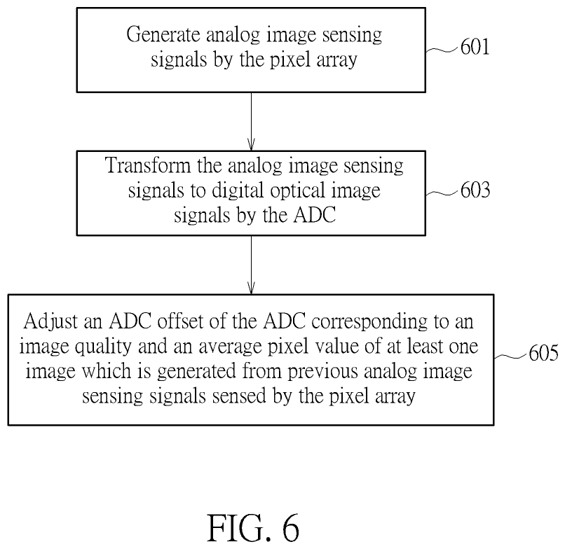

Based upon above-mentioned embodiments, an ADC control method can be acquired, which is applied to an image sensing device comprising a pixel array and an ADC. FIG. 6 is a flow chart illustrating an ADC offset control method, according to one embodiment of the present invention, which comprises following steps:

### Step 601

Generate analog image sensing signals by the pixel array (e.g., the pixel array 101 in FIG. 1).

### Step 603

Transform the analog image sensing signals to digital optical image signals by the ADC. (e.g., the ADC 105 in FIG. 1).

### Step 605

Adjust an ADC offset of the ADC corresponding to an image quality and an average pixel value of at least one image which is generated from previous analog image sensing signals sensed by the pixel array.

In one embodiment a lighting time of a light source decreases corresponding to the increasing of the ADC offset, as shown in the embodiment of FIG. 3. In another embodiment, a lighting time of the light source increases corresponding to the decreasing of the ADC offset, as shown in the embodiment of FIG. 5. Please note, besides the light time of the light source, a sensing time of the pixel array can also be controlled following the same rule.

In view of above-mentioned embodiments, power consumption of the optical mouse can be saved, since the lighting time of the light source can be decreased when the motion can still be correctly computed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image sensing device, comprising:
a pixel array, configured to generate analog image sensing signals;
an ADC, configured to transform the analog image sensing signals to digital optical image signals; and
an offset control circuit, configured to adjust an ADC offset of the ADC corresponding to an image quality and an average pixel value of at least one image which is generated from previous analog image sensing signals sensed by the pixel array.

2. The image sensing device of claim 1, wherein the offset control circuit increases the ADC offset if the image quality is higher than a first image quality threshold and the average pixel value is lower than a first pixel value threshold.

3. The image sensing device of claim 2, further comprising:
a light source, configured to emit light outer the image sensing device;
wherein a lighting time of the light source decreases corresponding to the increasing of the ADC offset.

4. The image sensing device of claim 2, wherein the image quality decreases corresponding to the increasing of the ADC offset.

5. The image sensing device of claim 1, wherein the offset control circuit decreases the ADC offset if the image quality is lower than a second image quality threshold and the average pixel value is higher than a second pixel value threshold.

6. The image sensing device of claim 5, further comprising:
a light source, configured to emit light outer the image sensing device;
wherein a lighting time of the light source increases corresponding to the decreasing of the ADC offset.

7. The image sensing device of claim 5, wherein the image quality increases corresponding to the decreasing of the ADC offset.

8. The image sensing device of claim 1, wherein the image sensing device is located on a working surface, and the image quality corresponds to a surface quality of the working surface.

9. The image sensing device of claim 1, wherein the image sensing device is an optical mouse.

10. An ADC control method, applied to an image sensing device comprising a pixel array and an ADC, comprising:
(a) generating analog image sensing signals by the pixel array;
(b) transforming the analog image sensing signals to digital optical image signals by the ADC; and
(c) adjusting an ADC offset of the ADC corresponding to an image quality and an average pixel value of at least one image which is generated from previous analog image sensing signals sensed by the pixel array.

11. The ADC control method of claim 10, wherein the step (c) increases the ADC offset if the image quality is higher than a first image quality threshold and the average pixel value is lower than a first pixel value threshold.

12. The ADC control method of claim 11,
wherein the image sensing device comprises a light source configured to emit light outer the image sensing device;
wherein the ADC control method comprises:
decreasing a lighting time of the light source corresponding to the increasing of the ADC offset.

13. The ADC control method of claim 11, wherein the image quality decreases corresponding to the increasing of the ADC offset.

14. The ADC control method of claim 10, wherein the step (c) decreases the ADC offset if the image quality is lower than a second image quality threshold and the average pixel value is higher than a second pixel value threshold.

15. The ADC control method of claim 14, further comprising:
wherein the image sensing device comprises a light source configured to emit light outer the image sensing device;
wherein the ADC control method comprises:
increasing a lighting time of the light source corresponding to the decreasing of the ADC offset.

16. The ADC control method of claim 14, wherein the image quality increases corresponding to the decreasing of the ADC offset.

17. The ADC control method of claim 10, wherein the image sensing device is located on a working surface, and the image quality corresponds to a surface quality of the working surface.

18. The ADC control method of claim 10, wherein the image sensing device is an optical mouse.

19. An electric apparatus, comprising:
an image sensor, configured to sense a working surface which the electric apparatus is moved on and determine an image quality of the surface; and
a light source, configured to illuminate the working surface with a first light intensity when the image quality is higher than a first image quality threshold, the light source is configured to illuminate the working surface with a second light intensity when the image quality is lower than a second image quality threshold, wherein the first light intensity is lower than the second light intensity.
